(19) United States
(12) Patent Application Publication
(10) Pub. No.: US 2008/0001052 A1
(43) Pub. Date: Jan. 3, 2008

(54) User adjustable storage arrangement

(76) Inventors: D. Scott Kalous, Kenosha, WI (US); Gary Burmesch, Port Washington, WI (US); Scott Czarnecki, Mukwonago, WI (US); Rebecca Brooke Manthe, Chicago, IL (US); Ron Theis, Kewaskum, WI (US)

Correspondence Address: CALFEE, HALTER & GRISWOLD LLP, 1400 KEYBANK CENTER, 800 SUPERIOR AVENUE, CLEVELAND, OH, 44114, US

(21) Appl. No.: 11/701,726

(22) Filed: Feb. 2, 2007

Related U.S. Application Data
(60) Provisional application No. 60/765,060, filed on Feb. 3, 2006.
(60) Provisional application No. 60/765,052, filed on Feb. 3, 2006.
(60) Provisional application No. 60/765,751, filed on Feb. 6, 2006.
(60) Provisional application No. 60/765,753, filed on Feb. 6, 2006.
(60) Provisional application No. 60/855,581, filed on Oct. 31, 2006.

(51) Int. Cl. F16M 13/02; B65G 47/00

(52) U.S. Cl. 248/544; 414/800

(57) ABSTRACT

A mountable storage arrangement for mounting to a receiver includes a draw tube, a hinge portion, a support member, and a locking member. The draw tube includes first and second end portions, the first end portion being configured to be secured to the receiver. The hinge portion is assembled to the draw tube. The support member is connected to the draw tube at the hinge portion and is pivotable between a lowered position and an upright position. The locking member is connected with the hinge portion and may be movable between an unlocking condition and a locking condition for selectively securing the support member in one or more of the upright position, the lowered position, and at least one intermediate position between the upright position and the lowered position.

### CROSS REFERENCE TO RELATED APPLICATIONS

This application claims the benefit of the following United States Provisional Patent Applications, the entire disclosures of which are hereby incorporated by reference, to the extent that they are not conflicting with the present application: App. Ser. No. 60/765,060, entitled “Cargo Cover” and filed Feb. 3, 2006; App. Ser. No. 60/765,052, entitled “Cargo Carrier” and filed Feb. 3, 2006; App. Ser. No. 60/765,751, entitled “Modular Cargo System” and filed Feb. 6, 2006; App. Ser. No. 60/765,753, entitled “Vehicle Cargo Pack” and filed Feb. 6, 2006; and App. Ser. No. 60/855,581, entitled “User Operated Rack Release” and filed Oct. 31, 2006.

### FIELD OF THE INVENTION

The present invention relates to mountable storage arrangements and to mechanisms and methods for moving a mountable storage arrangement, such as a rack, between multiple positions, for example, to access an item stored or mounted on the rack or to load an item onto a rack.

### BACKGROUND OF THE INVENTION

Storage arrangements or devices, such as, for example, racks may provide secure storage for many different types of items, including, for example, luggage, bicycles, skis, and other cargo. Many racks are configured to mount to a vehicle, such as, for example, a car, light truck, or sport utility vehicle. In some circumstances, an item stored on a rack may be heavy, large, or otherwise awkward to lift or lower, which may make it difficult to lift the item onto the rack or to retrieve the item from the rack, particularly where the rack is configured to store items relatively high off the ground.

### SUMMARY

As described in the present application, a mountable storage arrangement for mounting to a receiver of a vehicle may be configured to be user adjustable, for example, to facilitate loading (or unloading) an item onto (or from) the mountable storage arrangement, or to move the mountable storage arrangement to allow access to a rear portion of the vehicle. According to one inventive aspect, the mountable storage arrangement may include a draw tube configured to be secured to the receiver and a support member connected to the draw tube and pivotable between an upright position and a lowered position. The mountable storage arrangement may also include a locking member movable between an unlocking condition and a locking condition for selectively securing the support member in at least the upright position. In an exemplary embodiment, the locking member also selectively secures the support member in the lowered position and at least one intermediate position between the upright position and the lowered position. In another exemplary embodiment, the mountable storage arrangement is configured such that the support member is substantially parallel to the draw tube when in the lowered position, which may, for example, provide for a wide range of pivotable positions.

### BRIEF DESCRIPTION OF THE DRAWINGS

Features and advantages of the invention will become apparent from the following detailed description made with reference to the accompanying drawings, wherein:

FIG. 1 is a perspective view of a mounting arrangement for a cargo storage device;

FIG. 2 is a perspective view of the mounting arrangement of FIG. 1, with the support member in a lowered position;

FIG. 3 is a perspective view of the mounting arrangement of FIG. 1, with the support member in an intermediate position;

FIG. 4 is a perspective view of a user operable locking member for adjusting the position of a hinge portion of a mounting arrangement;

FIG. 5A is an upper perspective view of the locking member of FIG. 4, with portions of the housing members hidden to illustrate additional features of the locking member;

FIG. 5B is side view of the locking member of FIG. 4, with portions of the housing members hidden to illustrate additional features of the locking member;

FIG. 5C is an exploded perspective view of the locking member of FIG. 4;

FIG. 6 is a side perspective view of another locking member, with portions shown in phantom to illustrate additional features of the locking member;

FIGS. 7A-7D are schematic illustrations of a method of operating a user operable locking member for adjusting the position of a support member of a mounting arrangement;

FIG. 8 is a partially exploded perspective view of a mounting arrangement with a user adjustable support member including a mounting rack for securing an item;

FIG. 9 is a side cross-sectional view of a mounting arrangement with a rigid container storage device;

FIG. 10A is a perspective view of the rigid container storage device of FIG. 9 assembled with a mounting arrangement;

FIG. 10B a perspective view of another rigid container storage device for assembly with a mounting arrangement

FIG. 10C is a perspective view of another rigid container storage device for assembly with a mounting arrangement;

FIGS. 11A, 11B, and 11C are side schematic illustrations of a method for loading a storage device onto a vehicle mounted mounting arrangement;

FIG. 12 is a perspective view of a mounting arrangement with a frame for retaining a storage container;

FIG. 13 is a perspective view of a platform for assembly with a mounting arrangement for a vehicle;

FIG. 14 is a perspective view of a wheel gripping bicycle rack for assembly with a mounting arrangement for a vehicle;

FIG. 15A is a perspective view of a mounting arrangement with a frame for retaining an item to be stored;

FIG. 15B is a perspective view of the mounting arrangement of FIG. 15A with a flexible storage container retained by the frame;

FIG. 16 is a side schematic view of a mounting arrangement retaining a flexible storage container;

FIG. 17A is a perspective view of a mounting arrangement with a frame and platform for retaining an item to be stored;

FIG. 17B is a side schematic view of the mounting arrangement of FIG. 17A, with a flexible storage container retained by the frame and platform;

FIG. 18A is a schematic view of a modular mounting arrangement for a vehicle;

FIG. 18B is a schematic view of another modular mounting arrangement for a vehicle;

FIG. 19 is a perspective view of a mounting arrangement with a platform and flexible enclosure for retaining an item to be stored;

FIG. 20 is a perspective view of a mounting arrangement with a bicycle rack and a flexible enclosure; and

FIG. 21 is a partial perspective view of a flexible enclosure assembled with a draw tube of a mounting arrangement.

### DETAILED DESCRIPTION OF THE INVENTION

This Detailed Description of the Invention merely describes embodiments of the invention and is not intended to limit the scope of the specification in any way. Indeed, the invention as described is broader than and unlimited by the embodiments discussed herein, and the terms used have their full ordinary meaning.

The present application contemplates a mountable storage arrangement, for example, for mounting to a receiver of a vehicle. The mountable storage arrangement may be configured to accommodate one or more retaining members for securing one or more items to the arrangement. Many different types of retaining members may be utilized, including, for example, frames or racks (such as bicycle racks or ski racks), platforms (to support, for example, luggage or a lawnmower), or containers (including rigid or flexible containers, such as cargo carriers). Examples of such retaining members are described in greater detail below.

To accommodate attachment to different types of retaining members, to facilitate loading or unloading of items on the retaining member, or to allow access to a rear portion of the vehicle, the mounting arrangement may include a support member with which the retaining member is connected, with the support member being configured to be adjustable for movement of the retaining member. In one embodiment, the support member may be pivotally connected with a draw tube by a hinge portion (which may be integral with or separate from the support member), such that the support member may be pivoted to different positions with respect to the draw tube. In one such embodiment, the support member, which may, for example, be a tube or other elongated frame member, may be pivotable between an upright position and a lowered position. In one example, the support member positions the retaining member in a storing orientation when in the upright position, and the support member positions the retaining member in a loading orientation when in the lowered position. In the storing orientation, one or more items may be safely stored on or in the retaining member, for example, during operation of the vehicle. In the loading orientation, one or more items may be more easily loaded onto, or removed from, the retaining member. In still another embodiment, a loading orientation may accommodate attachment of the retaining member to the support member, or detachment of the retaining member from the support member.

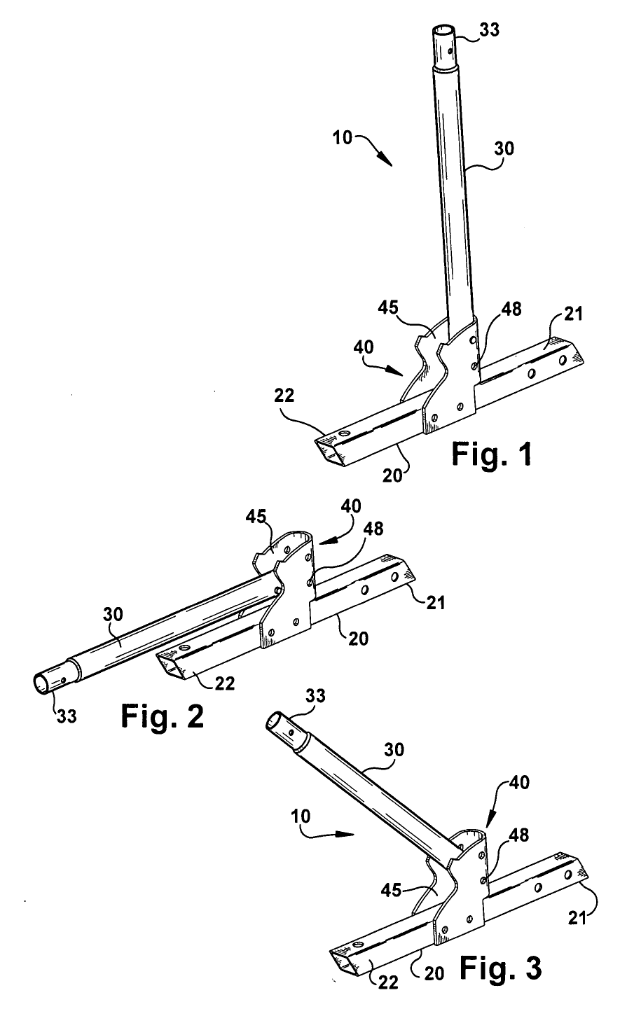

Many different mountable storage arrangements may be contemplated by the present application. FIGS. 1-3 illustrate an exemplary embodiment of one such mountable storage arrangement 10. The exemplary arrangement 10 includes a draw tube 20 adapted to be assembled with a receiver at least at a first end 21. A second end 22 may also be configured to be assembled with the receiver. Additionally or alternatively, the second end 22 may include other mounting features, such as a ball mount, to facilitate attachment with other structures. A support member 30 is connected with the draw tube by a hinge portion 40. While the hinge portion 40 may comprise many different types of hinges, joints, bearings, or other such components, in the illustrated embodiment, the hinge portion 40 includes a bracket 45. The exemplary hinge portion 40 also includes a pivot pin 48, assembled with the support member 30 to allow the support member to pivot with respect to the draw tube 20 and with respect to the bracket 45. The bracket 45 may be constructed to provide additional support for the support member 30 when the support member is in an upright position, as shown in FIG. 1.

The support member 30 may be configured to allow for attachment of a retaining member or an item to be stored. Many different configurations or mechanisms may be provided for such an attachment, including, for example, fasteners, pins, threaded connections, or a necked down end portion 33 (shown in FIGS. 1-3) adapted to press fit into a tube end portion of a corresponding retaining member (not shown).

The exemplary support member 30 may be pivoted to a range of positions, including, for example, the upright position shown in FIG. 1, the lowered position shown in FIG. 2, and one or more intermediate positions between the upright and lowered positions. An exemplary intermediate position is shown in FIG. 3. By pivoting the support member 30 to a lowered position (either a fully lowered position or an intermediate position), attaching a retaining member to the support member and/or securing an item to the support member for storage may be facilitated, particularly where the retaining member and/or item are particularly heavy or awkward to lift. Also, lowering of the support member 30 may be necessary to access a rear portion of the vehicle, such as a door, trunk, or window. As shown in FIG. 2, the support member 30 may be horizontal or substantially parallel to the draw tube 20 when in the lowered or fully lowered position, such that the draw tube may support a length of the support member in the lowered position. In other embodiments (not shown), the lowered or fully lowered position of the support member 30 may be limited to an angle above horizontal, or the support member 30 may be permitted to pivot beyond a horizontal position or below the draw tube 20, for example, to further assist in mounting an item to the support member 30.

According to an inventive aspect of the present application, a locking member may be provided with the mountable storage arrangement to secure the support member 30 in one or more positions, including, for example, an upright position, a lowered position, and/or one or more intermediate positions between the upright and lowered positions. In addition to securely holding the support member 30 (and corresponding retaining members and/or stored items) in an upright position for storage of the retaining member and/or items during operation of the vehicle, the ability to lock the support member in intermediate or lowered positions may provide additional advantages. For example, locking the support member 30 in an intermediate (or not fully lowered) position may further facilitate loading or unloading an item, or may allow for ground clearance with an item secured to the support member 30. As still another example, a retaining member or item to be secured to the support member may be configured for secure storage with the support member in a non-upright position. By allowing the support member 30 to be locked or secured in multiple pivotal positions, different types of retaining members or items may be accommodated.

According to an inventive aspect of the present application, a mountable storage arrangement for mounting to the receiver of a vehicle may include a support member pivotable between an upright position (which may, but need not be, vertically oriented) and a lowered position, and securable in one or more pivotal positions by a locking member. In one embodiment, the support member may be secured by the locking member in any of the upright position, the lowered position, and at least one intermediate position between the upright position and the lowered position.

Many different types of locking members may be utilized to secure the support member in the desired orientation. In one embodiment, the locking member may include one or more locking pins that engage openings in a hinge portion connecting the support member to the draw tube, in order to secure the support member in the desired orientation. The hinge portion may be provided with multiple openings or sets of openings corresponding to different pivotal positions of the support member with respect to the draw tube. While the locking pin may comprise a loose pin or fastener insertable through corresponding openings in the hinge portion, in another embodiment, the locking member includes a user operable assembly, including, for example, a pedal, lever, or knob, that may be operated by a user to disengage the locking pins for adjustment of the support member, and then re-engage the locking pins to secure the support member in the desired orientation.

According to another inventive aspect of the present application, a user operated assembly may be configured such that the pedal, lever, or other such component is securely stored or otherwise inoperable until the user wishes to operate the mechanism, thereby preventing undesired release or adjustment of the support member due to inadvertent bumping or other such manipulation of the assembly. To adjust the support member, the pedal or lever is moved from a secured, locked, or inoperable condition to an operable condition, in which the pedal or lever may be operated to adjust the support member, for example, to release the support member from an upright condition.

In one embodiment, a user operated mechanism includes one or more retractable locking pins that rigidly hold the support member in a desired position, such as an upright position, when the pins are extended through corresponding openings in the support member and/or the hinge portion, thereby fixedly securing the support member with respect to the draw tube. When the pins are retracted from the corresponding openings, the support member becomes free to move with respect to the locking member or mechanism. In one such embodiment, a pivot pin passes through aligned openings in the hinge portion, allowing the support member to pivot about the pivot pin when the retractable pins are disengaged from the rack. The support member may be fixed to or integral with the hinge portion, with the hinge portion pivoting with respect to the draw tube (for example, about a pivot pin) for adjustment of the support member orientation. Further, the retractable locking pins may be spring loaded to allow the pins to spring into engagement with a set of openings in when the pins become aligned with the openings.

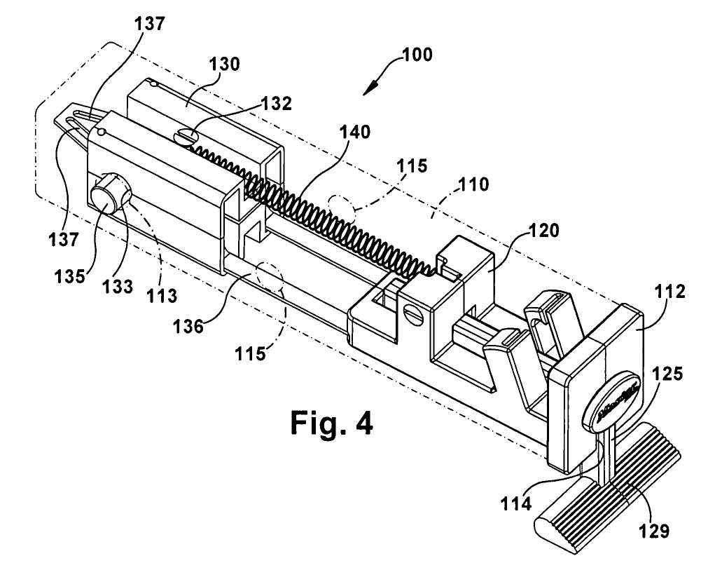

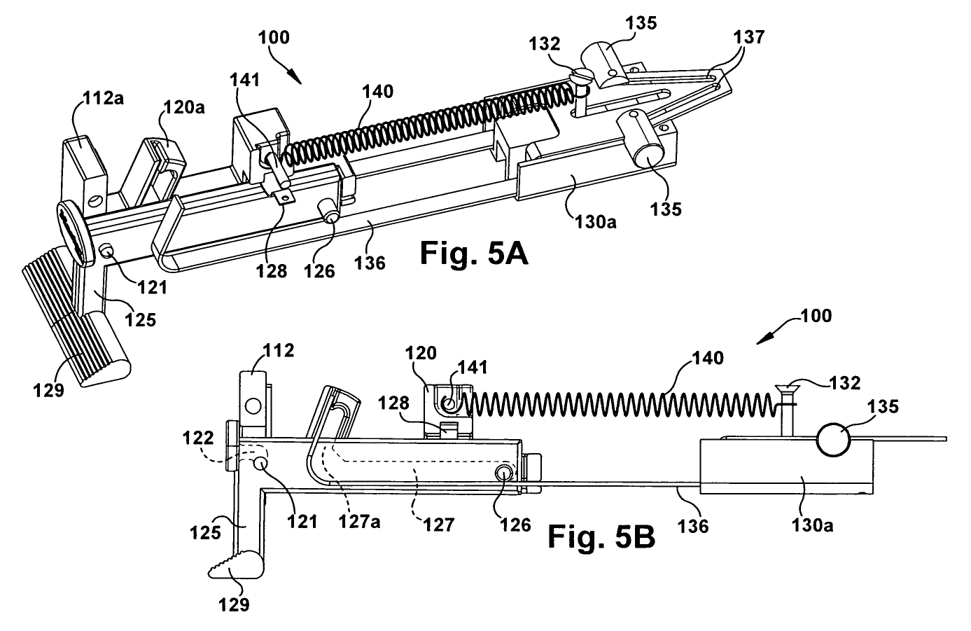

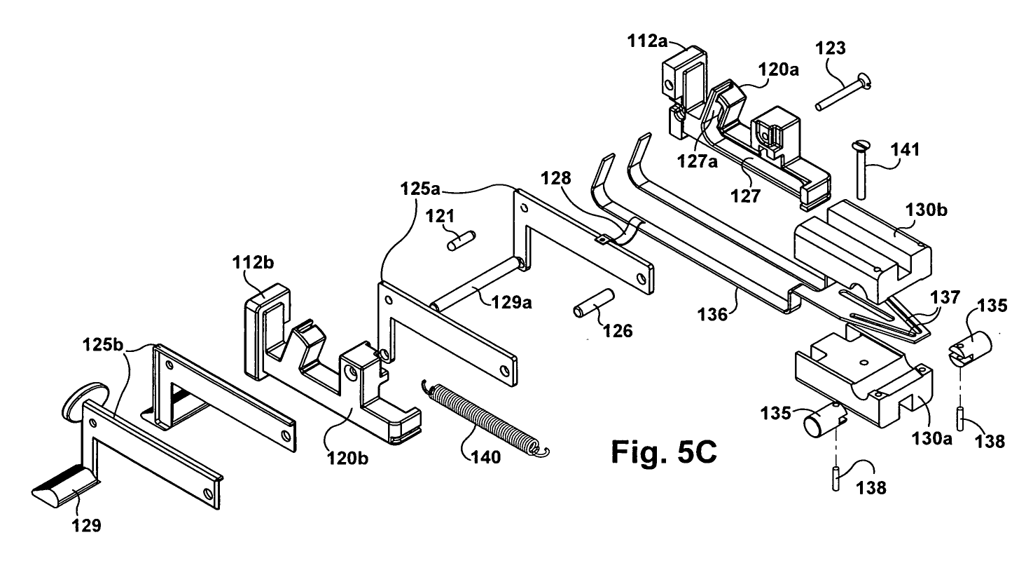

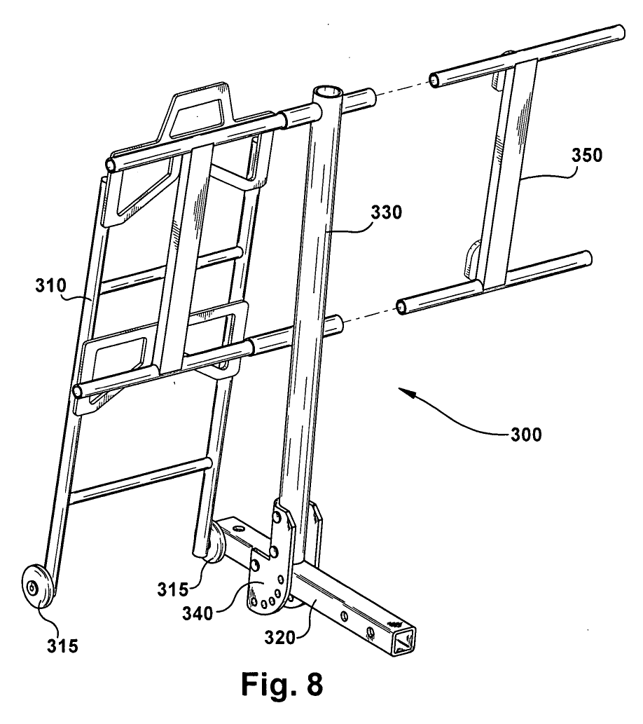

FIGS. 4-5C illustrate an exemplary embodiment of a user operated assembly 100 for a mountable storage arrangement, such as, for example, the exemplary rack 300 of FIG. 8. The exemplary assembly 100 is assembled with a draw tube 110 (see FIG. 4), which may be mounted to the receiver of a vehicle.

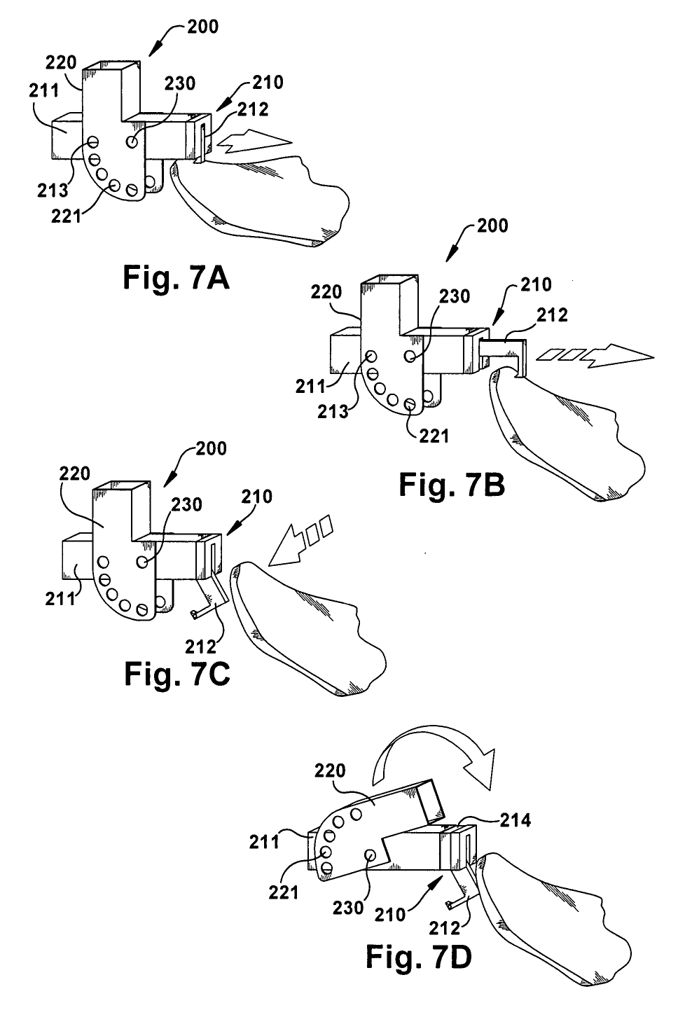

The assembly 100 may include a lever 125 that is in communication with one or more retracting pins 135 extending through openings 113 (see FIG. 4) in the draw tube 110, such that operation of the lever causes the pins 135 to retract out of engagement with corresponding openings in a hinge portion (for example, the openings 221 in the hinge portion 220 of FIGS. 7A-D). Upon retraction of the retracting pins 135 from the openings, the hinge portion may be free to move with respect to the draw tube 110, for example, by pivoting the hinge portion 220 about a pivot pin 230 (see FIGS. 7A-D) which extends through aligned openings 115 in the draw tube 110 (see FIG. 4) and hinge portion 220 (see FIGS. 7A-D).

Many different configurations may be used to orient the lever 125 and pins 135 in the release arrangement 100. As an example, in the illustrated embodiment, the lever 125 may extend from an outer housing 120 disposed in the draw tube 110, while the retracting pins 135 may extend from an inner housing 130 disposed in the draw tube 110. The inner housing 130 may include inner housing halves 130a, 130b, as shown in FIG. 5C, which may be secured together by pins 131 and a screw 132. The lever 125 may extend through a front opening 111 in the draw tube 110. The front opening may be at least partially covered with a cap 112, which may be assembled with the outer housing 120 as cap halves 112a, 112b and provided with a slot 114 (see FIG. 4) to accommodate the lever 125. The pins 135 may extend through aligned holes or openings 133, 113 in the inner housing 130 and draw tube 110. The pins 135 may be configured such that they at least partially engage the draw tube openings 113 even in the retracted position, thereby maintaining alignment of the pins 135 with the openings 113.

Many different configurations may be used to connect the lever 125 with the retracting pins 135, including the use of springs, linkages, and other such mechanisms. In one embodiment, the lever 125 may be directly or indirectly connected with a retracting linkage adapted to translate axial movement of the retracting linkage to lateral (inward and outward) movement of the retracting pins 135. In the illustrated embodiment, the lever 125 is indirectly connected (via the outer housing 120) with a wedge plate 136 that is fixed to the outer housing 120 and extends through the inner housing 130. The retracting pins 135 are assembled with angled slots 137 in the wedge plate 136, for example, with dowel pins 138 (see FIGS. 5A and 5C). When the wedge plate 136 is moved axially toward the front opening 111 of the draw tube 110, the dowel pins 138 ride inward along the angled slots 137, causing the retracting pins 135 to retract into the inner housing 130. When the wedge plate 136 is moved axially away from the front opening 111 of the draw tube 110, the dowel pins 138 ride outward along the angled slots 137, causing the retracting pins 135 to extend from the inner housing 130.

The connection between the lever 125 and the retracting linkage (e.g., the wedge plate 136) may be provided using many different configurations. As one example, a release arrangement may include a pull lever directly connected with the retracting linkage, such that axial movement of the lever results in axial movement of the retracting linkage. As another example, the lever 125 may be pivotally connected to an axially movable element, such as, for example, an outer housing, that is attached to the retracting linkage, such that the lever may be pivoted, for example, like a foot pedal, to axially move the retracting linkage and retract the retracting pins 135. Further, the lever 125 may be movable between a pivotable or operable position, at which the lever 125 may be operated to retract the pins 135, and a non-pivotable or inoperable position, at which the lever 125 may not be operated, for example, to avoid unintentional operation of the lever 125.

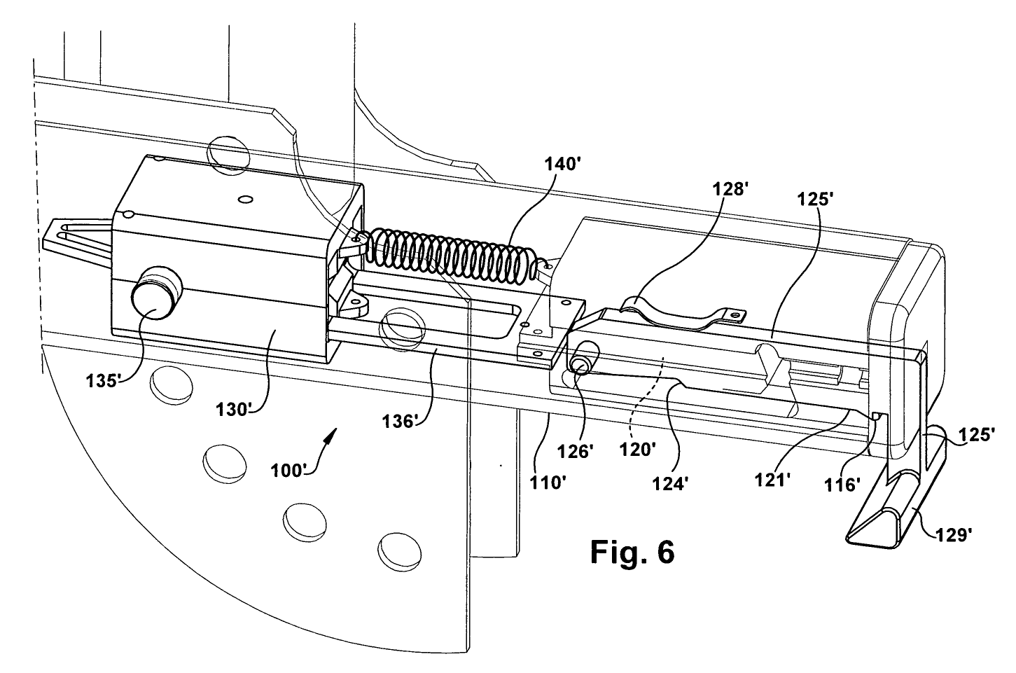

In the illustrated embodiment, the lever 125 is slideable within the outer housing 120 between a pivotable or operable position and a non-pivotable or inoperable position. The lever 125 may include a dowel pin 126 that slides in a slot 127 in the outer housing 120 between pivotable and non-pivotable positions. To prevent inadvertent sliding of the lever 125 in the outer housing 120, the lever 125 may include a retaining pin 121 that engages a recessed portion 122 of the outer housing 120 when the lever 125 is in the non-pivoting position. To slide the lever 125 toward the pivoting position, the lever is slightly lifted to disengage the retaining pin 121 from the recessed portion 122 of the outer housing 120. In another embodiment, as shown in FIG. 6, the lever may include a detent or notch 121′ that engages a recessed portion 116′ in the draw tube 110′ when the lever 125′ is in the non-pivoting position. To slide the lever toward the pivoting position, the lever is slightly lifted to disengage the notch 121′ from the recessed portion 116′. In either embodiment, a biasing member, such as a spring 128, 128′, may be provided in the outer housing 120, 120′ to bias the lever 125, 125′ into engagement with the outer housing 120 or draw tube 110′ for retention of the lever 125, 125′ in the inoperable position.

When the lever 125 is moved to the pivotable position, the dowel pin 126 aligns with an angled extension 127a of the slot 127. As shown in FIG. 6, the lever 125′ may be provided with a second notch 124′ to engage the draw tube 110′ in the pivotable position. This second notch 124′ acts as a fulcrum about which the lever 125′ may pivot. While not shown, a similar feature may be provided in the embodiment of FIGS. 4-5C.

When the lever 125 is pivoted, the dowel pin 126 slides along the angled extension 127a of the slot 127, and the outer housing 120 is axially extended from the draw tube 110. This axial movement of the outer housing 120 moves the wedge plate 136, which in turn retracts the retracting pins 135, thereby disengaging the pins 135 from the hinge portion to allow for adjustment of the support member. To facilitate re-engagement of the pins 135 with the hinge portion, such as with openings corresponding to the original hinge portion orientation or to an alternate hinge portion orientation, the outer housing 120 may be connected to a fixed portion of the release arrangement 100, such as the draw tube 110 or the inner housing 130, by one or more biasing members, which act to return the retracting pins 135 to an extended condition when pivoting force to the lever 125 is removed. In the illustrated embodiment, a tension spring 140 is provided between the outer housing 120 and the inner housing 130 to provide the desired biasing force. The exemplary spring 140 may be connected to the outer and inner housings 120, 130 in many different ways. For example, the spring 140 may be secured to the outer housing 120 by a pin 141, and to the inner housing 130 at a screw 132, as shown in FIGS. 5A and 5B.

While the lever 125 may be configured to be operated by a user in many different ways, in one embodiment, the lever 125 is adapted to be operated as a foot pedal. As such, the lever 125 may include a pedal portion 129 that may be engaged by a user's foot to lift the lever 125 (to disengage the lever 125 from the outer housing 120 or draw tube 110), to slide the lever 125 out of the draw tube 110 by dragging the pedal outward with the user's foot, and to pivot the lever 125 by pressing the user's foot against the pedal 129. The lever 125 with foot pedal 129 may be constructed in many different ways. In the illustrated embodiment, as shown in the exploded view of FIG. 5C, the lever assembly 125 may include internal lever members 125a and external cover members 125b which carry the pedal 129. The pedal 129 may be reinforced by an internal pedal pin 129a. The exemplary lever 125 also includes holes to retain the dowel pin 126 and retaining pin 121.

FIGS. 7A-D illustrate an exemplary method of operating a rack mount release or adjustment arrangement, such as, for example, the exemplary arrangements 100, 100′ of FIGS. 4-5C and FIG. 6. An assembly 200 includes a locking member 210 and a mounted hinge portion 220 which may be connected to or integral with a support member (not shown), such as the support member 30 of FIGS. 1-3. The hinge portion 220 as shown in FIG. 7A is rigidly secured in an upright orientation with respect to the locking member 210 by retracting pins 213 extending from a draw tube 211 into engagement with openings 221 in the hinge portion 220, and the lever 212 is retracted within a draw tube 211. The draw tube 211 may be assembled with a receiver (not shown). To access the lever 212, a user engages the lever 212, for example, with his or her foot, as shown in FIG. 7A. To prevent inadvertent withdrawal of the lever 212, the user may be required to lift the lever 212 slightly, thereby disengaging the lever 212 from the outer housing 214 or the draw tube 211, as further described above. The user may then withdraw the lever 212 from the outer housing 214 and draw tube 211, for example, using his or her foot, as shown in FIG. 7B. This operation may move the lever 212 to a pivotable position, for example, by aligning a dowel pin connected with the lever 212 with an angled slot, as shown and described in the embodiments of FIGS. 4-5C and FIG. 6. To retract the retracting pins 213 from the rack openings 221, the user may pivot the extended lever 212, such as by pressing the lever 212 with his or her foot like a pedal, as shown in FIG. 7C. A linkage between the lever 212 and the retracting pins 213 translates pivoting movement of the lever 212 to inward lateral movement of the pins 213, for example, by axially moving an outer housing 213 and a wedge plate connected with the pins, as shown in the illustrated embodiments. Once the retracting pins 213 have disengaged from the hinge portion openings 221, the hinge portion 220 may be rotated with respect to the release arrangement 210 about a pivot pin 230 extending through aligned openings in the hinge portion 220 and release arrangement 210, as shown in FIG. 7D. The orientation of the hinge portion may be adjusted by rotating the hinge portion such that another set of openings 221 align with the retracting pins 213. While the lever 212 remains extended, the lever may be pivoted to retract the pins 213 for another adjustment of the rack 220. To return the lever 212 to the non-pivoting position, the user may push the un-pivoted lever 212 back into the draw tube 211, thereby preventing inadvertent pivoting of the lever 212.

Many different mounted rack assemblies may be used with adjustment or release arrangements as described herein. FIG. 8 illustrates an exemplary mountable storage arrangement 300 which includes a removable rack 310, for example, for a backpack, assembled with a support member 330, and connected with a draw tube 320 at a hinge portion 340 by a locking member (not shown), such as the locking member assemblies 100, 100′ of FIGS. 4-5C and 6. As shown, the rack 310 may include wheels 315 to facilitate transportation of the rack 310 for mounting. Many different mechanisms may be used to removably attach the rack 310 to the arrangement 300. In the illustrated embodiment, a press fit tube arrangement is used. As shown, the support member 330 may be configured for attachment of a second rack 350 to the opposite side of the support member 330. Many other types of racks may be used, including, for example, bicycle racks, such as a quick clamping bicycle rack as described in co-pending U.S. patent application Ser. No. 11/455,437, entitled “Clamp,” filed Jun. 19, 2006, the entire disclosure of which is incorporated herein by reference, to the extent that it is not conflicting with the present application.

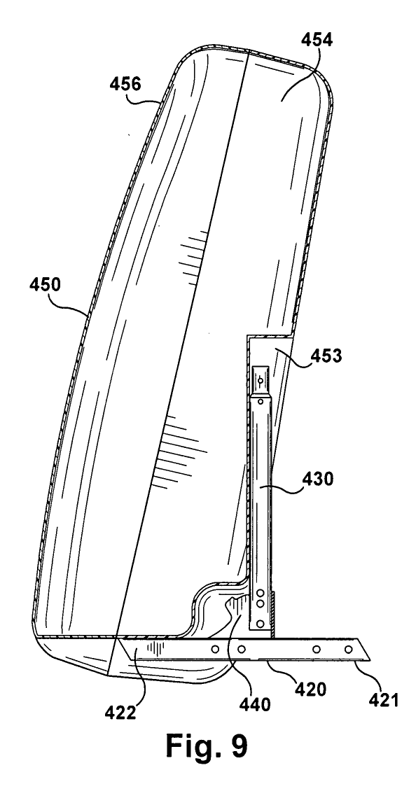

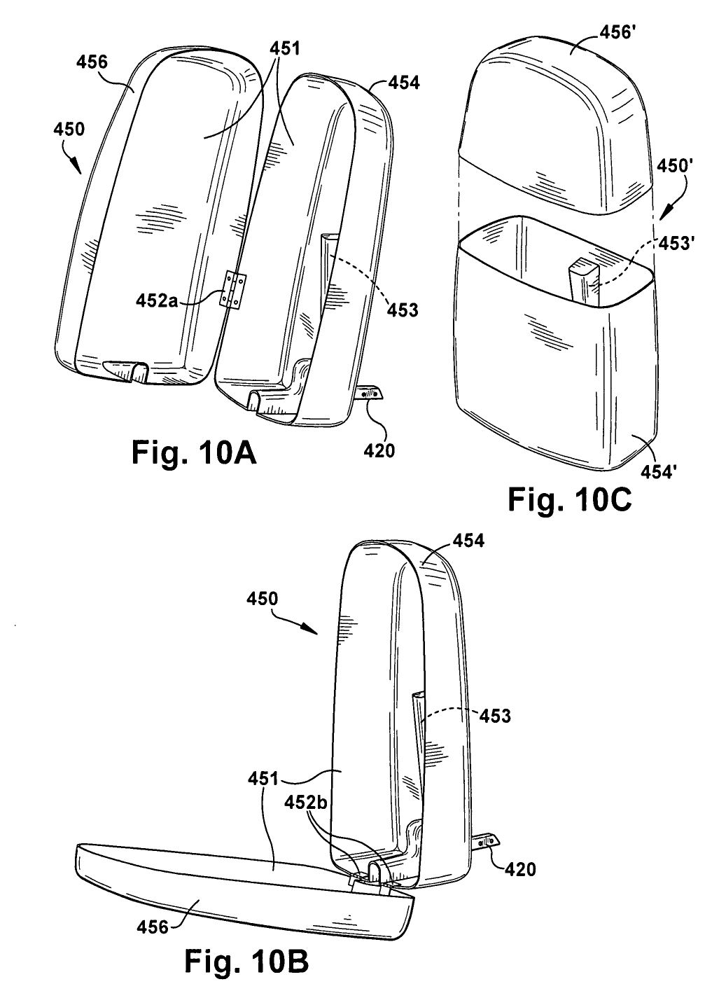

Many other types of retaining members, including, for example, frames, platforms, and containers, may be assembled with the support member and/or with the draw tube to accommodate one or more items to be stored on a vehicle. In one embodiment, the retaining member may include a rigid container or enclosure, similar to a conventional car top carrier, which may be attached with a mountable storage arrangement for storage at the rear of a vehicle in a vertical orientation. One such rigid container 450 is illustrated in FIG. 9 as connected with a mountable storage arrangement 410. The exemplary container 450 includes a base portion 454 and a cover portion 456, which may be secured together by hinges, latches, fasteners, press fit arrangements, and/or other such configurations to define an enclosure 451 (as shown in FIG. 10A) in which one or more items may be stored. The container may, for example, include hinges 452a on the side (as shown in FIG. 10A) for side opening, or hinges 452b on the bottom (as shown in FIG. 10B) for top opening. As shown in the illustrated embodiment, the base portion 454 may include a recessed portion 453 shaped to receive portions of any one or more of the support member 430, the draw tube 420, and the hinge portion 440, allowing the container 450 to fit closely with the mounting arrangement 410 in the upright position. In another embodiment, as shown in FIG. 10C, a container 450′ may include a bottom oriented base portion 454′ and a top oriented cover portion 456′, which may, for example, be press fit together to form a water tight seal.

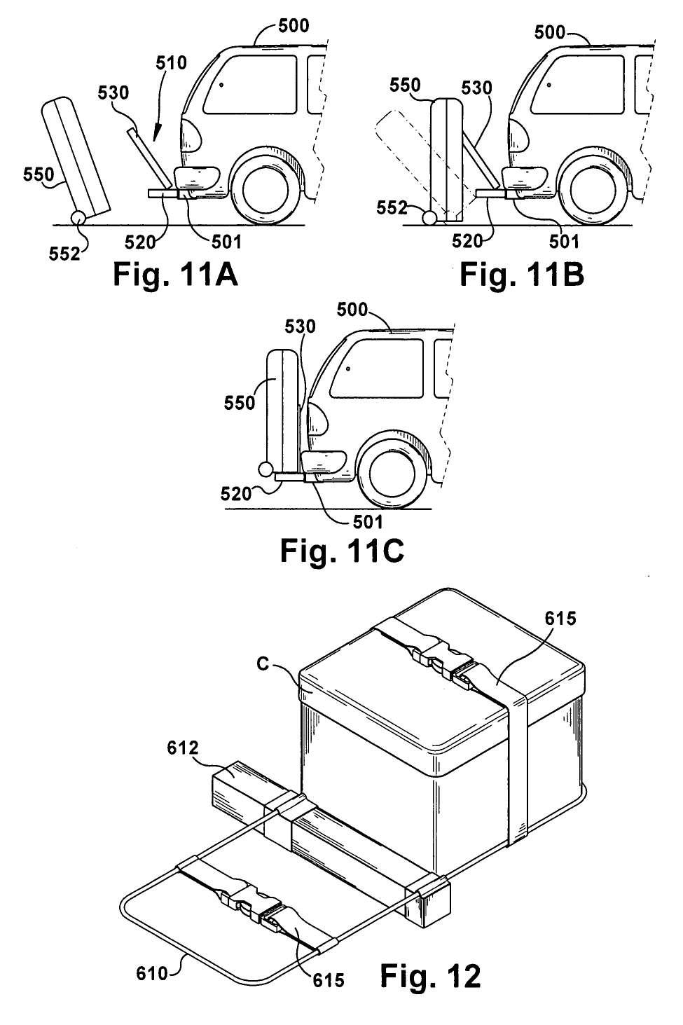

The base portion 454, 454′ may be adapted to connect with the mountable storage arrangement 410 using pins, fasteners, or other such connections. In one embodiment, the base portion 454 may be pivotally connected with the support member 430 to allow the container 450 to pivot with respect to the support member 430 as the support member pivots with respect to the draw tube 420. FIGS. 11A-C illustrate one method for using an adjustable mountable storage arrangement 510 with a container 550 that may be pivotally attached to a support member 530 of the arrangement 510, for mounting with a receiver 501 of a vehicle 500. As shown in FIG. 11A, the support member 530 is lowered to a loading orientation, and may be secured in this orientation using, for example, a locking member (not shown) as described herein. The container 550 is moved toward the storage arrangement 510. As shown, the container 550 may include wheels 552 to facilitate movement of the container 550. As shown in FIG. 11B, the support member 530 may be pivotally connected to the container 550 in a recessed portion of the container 550. This may allow for attachment of the container 550 while the container is still supported by the ground, thereby reducing mounting efforts. The support member 530 may then be pivoted to an upright position with respect to the draw tube 520, causing the container 550 to be pivoted to an upright or vertical orientation, as shown in FIG. 11C.

According to another inventive aspect of the present application, a draw tube and support member storage arrangement may be adapted to accommodate one or more of many different retaining members. FIGS. 12-20 illustrate many different exemplary embodiments of retaining members for use with a mountable storage arrangement.

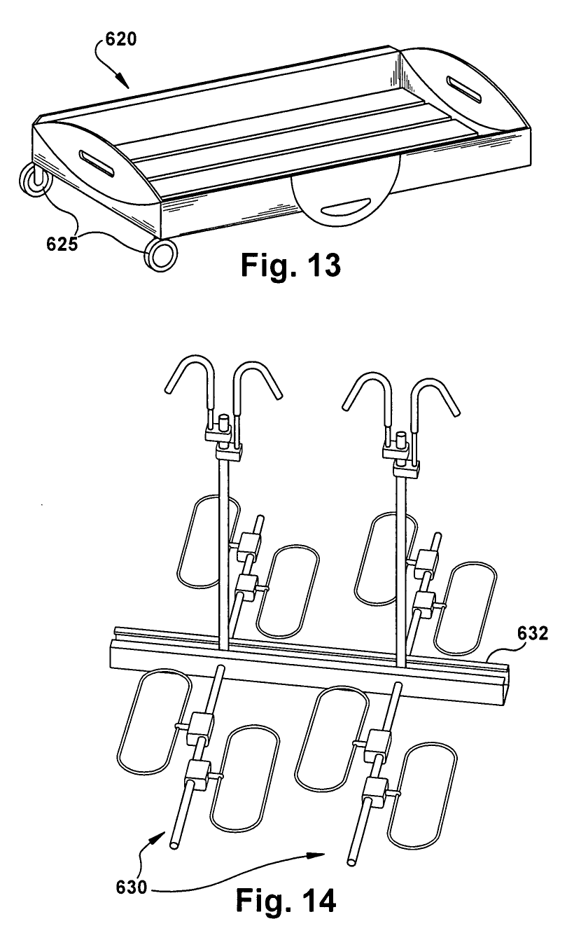

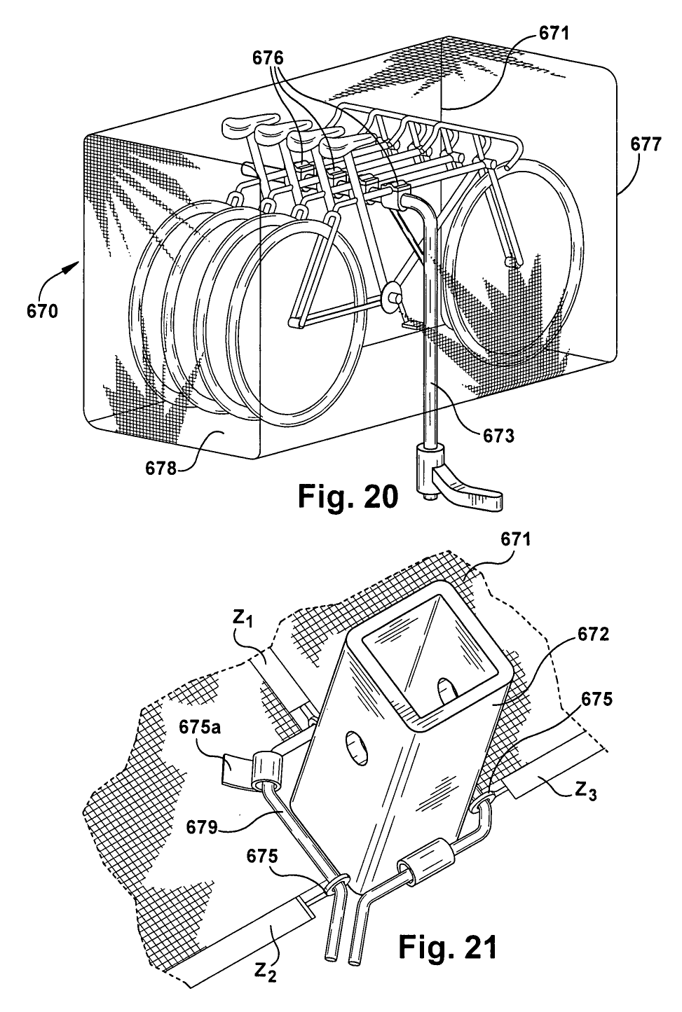

Many different types of retaining members may be connected with a draw tube to secure an item to a vehicle. In the embodiment of FIG. 12, a frame 610 may be assembled with the draw tube 612 for support of one or more items. Carrier straps 615 may be provided with the frame 610 to secure an item (such as a container C) to the frame 610. In the embodiment of FIG. 13, a cargo platform or tray 620 may be secured to the draw tube (not shown). The cargo tray 620 may include wheels 625 on at least one end to allow the cargo tray 620 (and its contents) to be more easily pushed or pulled to the vehicle. The cargo tray 620 may also be configured to pivotally attach to the draw tube and lock in a desired orientation, to allow for attachment of the tilted cargo tray 620, followed by pivoting of the cargo tray to a secure horizontal orientation. In the embodiment of FIG. 14, a wheel grip bicycle rack 630 may be assembled with a draw tube 632. The use of bicycle racks separate from the support member (unlike, for example, the exemplary bicycle rack of FIG. 20), allows for mounting of a different retaining member to the support member (not shown).

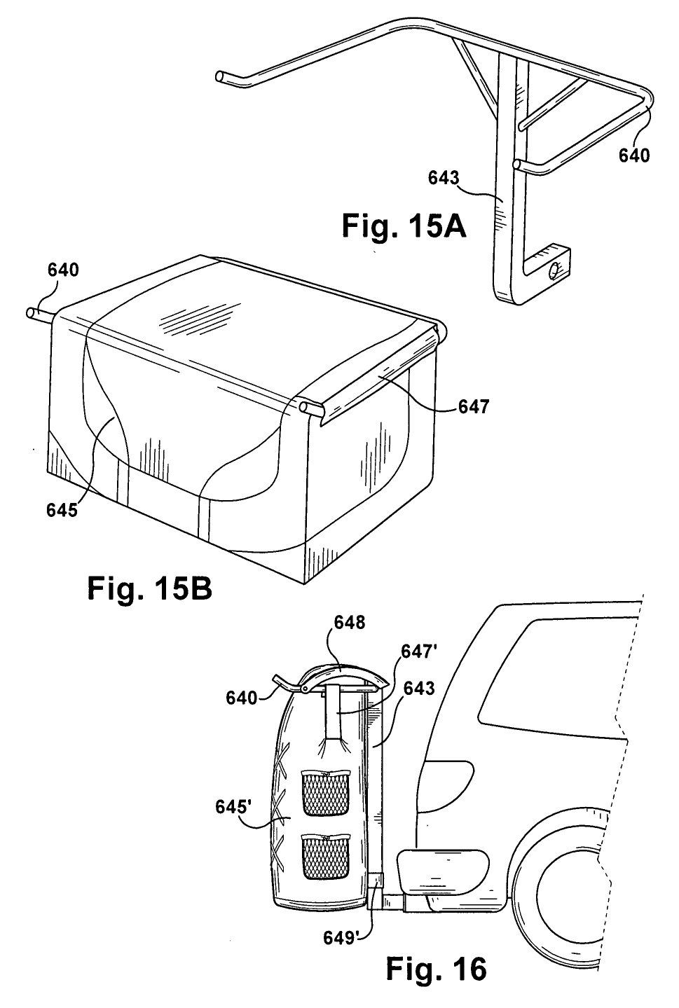

Many different types of retaining members may be connected with a pivotable support member to secure an item to a vehicle. As illustrated in FIGS. 15A, a rack or frame 640 may extend from the support member 643. As shown in FIG. 15B, a flexible enclosure, such as a fabric cargo bag 645, may be sized for hanging on the frame 640, for example, by inserting the frame 640 through channels 647 at the corners of the bag 645. As shown in FIG. 16, a flexible container or cargo pack 645′, which may resemble a backpack, may hang from the frame 640 by internal frame members 647′. The pack 645′ may be further stabilized by a strap 649′ extending from the back of the pack 645′ to wrap around the support member 643. A hinged clasp 648 may also be provided with the frame 640 to further secure the pack 645′.

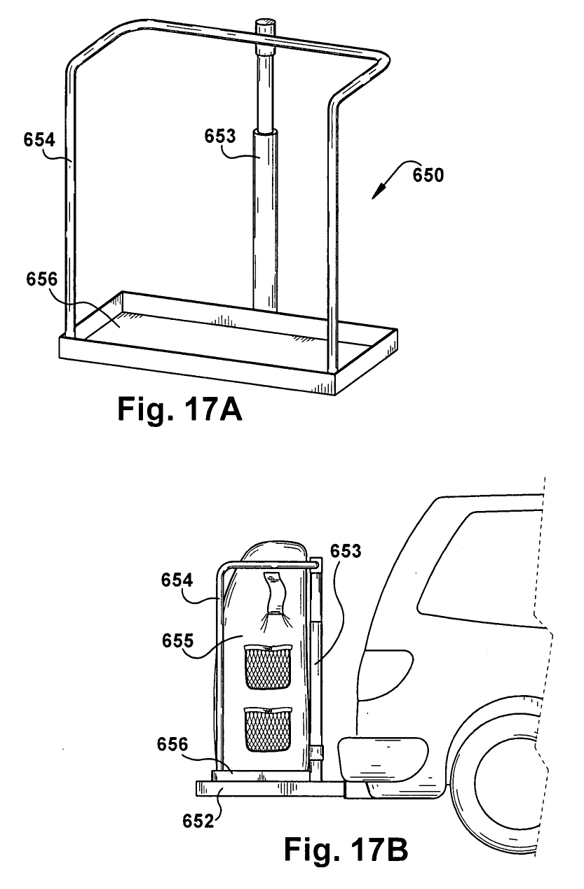

As shown in FIG. 17A, a retaining member 650 may include a frame 654, which may be supported by the support member 653, and a platform 656, which may be supported by the draw tube 652 (see FIG. 17B). This may provided additional support for a stored item or enclosure, such as the flexible cargo pack 655 of FIG. 17B. In another embodiment (not shown), the frame portion may be expandable, for example, using telescoping members, to accommodate larger items for storage.

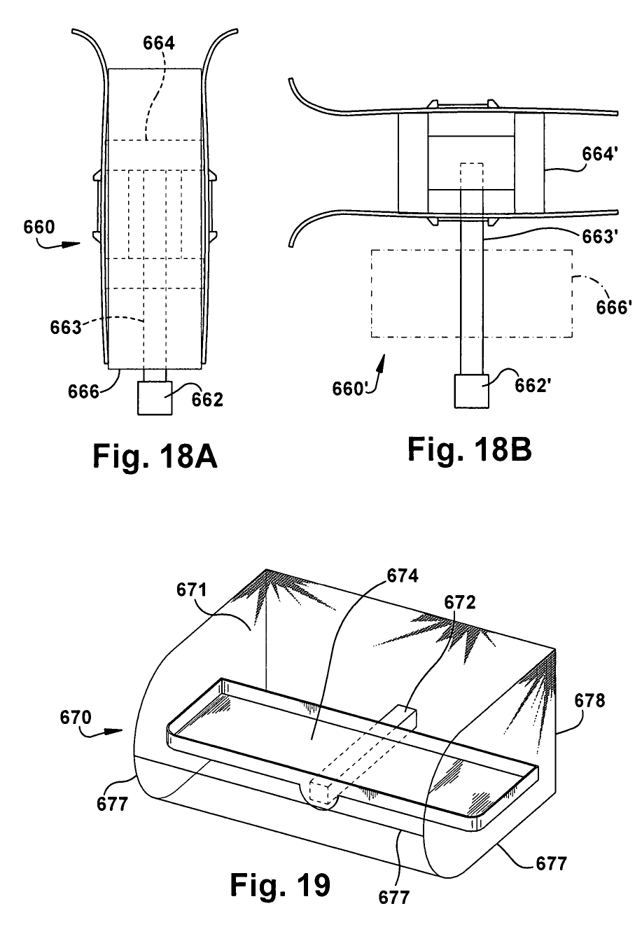

Modular retaining members may be configured to allow for the assembly of multiple retaining members to a vehicle at the same time. FIGS. 18A and 18B schematically illustrate two examples of storage arrangements 660, 660′ accommodating a ski or snowboard rack 664, 664′ and a second retaining member, such as a vertically oriented cargo carrier 666, as shown in FIG. 18A, or a horizontally oriented cargo tray 666′, as shown in FIG. 18B. Any of the retaining members may be supported by the draw tube 662, 662′, by the support member 663, 663′, or by both components. Other types of retaining members may similarly be combined.

In other embodiments, as shown in FIGS. 19 and 20, a mountable storage arrangement may further be provided with a flexible cargo cover 670, configured to enclose one or more retaining members and/or stored items, for example, to provide a weather resistant enclosure for a stored item. As illustrated in FIG. 19, the cover 670 may surround a platform 674 and a portion of the draw tube 672. In addition to a flexible sheet 671, which may, for example, be made of a waterproof fabric, the cargo cover 670 may include rigid frame members 677 to provide a tent-like enclosure for the retaining member 674 and its contents. The cargo cover 670 may also include a rigid or semi rigid base member 678, which may include a lightweight plastic tray, which may be assembled with the frame members 677 (such as with tube and socket connections or other suitable connections) to maintain the structure of the cargo cover 670. As shown in FIG. 20, the same exemplary cargo cover 670 may be re-oriented to surround a bicycle rack 676 and a portion of the support member 673 to which the bicycle rack 676 is mounted.

The flexible sheet 671 may be secured around the frame members and base using many different structures or mechanisms, including, for example, snaps, ties, hooks, or zippers. In one embodiment, as illustrated in FIG. 21, the flexible sheet 671 may be drawn around a portion of the mountable storage arrangement, such as the draw tube 672, by one or more zippers Z₁, Z₂, Z₃, which connect flaps of the flexible sheet 671 to define the enclosure. The flexible sheet 671 may be held in an enclosing or zipped condition by a cable 679 inserted through looped pull tabs 675 of the zippers Z₁, Z₂, Z₃ and/or strap loops 675a attached to the sheet 671. The cable 679 may be tied, locked, or otherwise secured to prevent accidental or unauthorized opening of the cargo cover. The cargo cover may include additional features (not shown), such as, for example, reflector strips for increased visibility or wired lighting for attachment to the tow wiring of a vehicle.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

We claim:

1. A mountable storage arrangement for mounting to a receiver, the arrangement comprising:
a draw tube including first and second end portions, the first end portion being configured to be secured to the receiver;
a hinge portion, assembled to the draw tube;
a support member connected to the draw tube at the hinge portion, the support member being pivotable between a lowered position and an upright position; and
a locking member connected with the hinge portion and movable between an unlocking condition and a locking condition for selectively securing the support member in any of the upright position, the lowered position, and at least one intermediate position between the upright position and the lowered position.

2. The arrangement of claim 1, further comprising a retaining member affixed to at least one of the draw tube and the support member, the retaining member being configured to retain an item to be stored.

3. The arrangement of claim 2, wherein the retaining member is selectively detachable from the at least one of the draw tube and the support member.

4. The arrangement of claim 2, wherein the retaining member comprises a frame.

5. The arrangement of claim 2, wherein the retaining member comprises a platform.

6. The arrangement of claim 2, wherein the retaining member comprises a container.

7. The arrangement of claim 6, wherein the container comprises a flexible enclosure.

8. The arrangement of claim 7, wherein the flexible enclosure is secured to the support member by a frame.

9. The arrangement of claim 6, wherein the container comprises a rigid enclosure.

10. The arrangement of claim 9, wherein the rigid enclosure is pivotable about the support member.

11. The arrangement of claim 1, wherein the support member is pivotable about the hinge portion.

12. The arrangement of claim 1, wherein the hinge portion is pivotable about the draw tube.

13. The arrangement of claim 1, further comprising a user operated lever for moving the locking member between the locking condition and the unlocking condition.

14. The arrangement of claim 13, wherein the lever is movable between operable and inoperable conditions.

15. A mountable storage arrangement for mounting to a receiver, the arrangement comprising:
a draw tube including first and second end portions, the first end portion being configured to be secured to the receiver;
a hinge portion, assembled to the draw tube;
a support member connected to the draw tube at the hinge portion, the support member being pivotable between a lowered position and an upright position, wherein the support member is substantially parallel to the draw tube when in the lowered position; and
a locking member connected with the hinge portion and movable between an unlocking condition and a locking condition for selectively securing the support member in at least the upright position.

16. The arrangement of claim 15 wherein the hinge portion is assembled to the draw tube between the first and second end portions.

17. The arrangement of claim 15, wherein the locking member is further configured to selectively secure the support member in at least one intermediate position between the upright position and the lowered position when in the locking condition.

18. The arrangement of claim 15, further comprising a user operated lever for moving the locking member between the locking condition and the unlocking condition.

19. A user adjustable mounting apparatus, comprising:
a base member;
a hinge portion, assembled to the base member;
a support member connected to the base member at the hinge portion, the support member being pivotable between first and second positions; and
a locking member connected to the hinge portion and movable between an unlocking condition and a locking condition for selectively securing the support member in at least the first position, the locking member comprising:
a user operated lever for moving the locking member between the unlocking condition and the locking condition;
at least one locking pin at least partially disposed within the base member; and
a wedge plate connected with the lever and configured to extend the at least one locking pin through a corresponding opening in the base member to engage at least one of the hinge portion and the support member when the lever is operated.

20. The apparatus of claim 19, wherein the lever is movable between operable and inoperable conditions.

21. A method for loading an item in a receiver mounted cargo carrier having a draw tube assembled with a receiver, and a support member connected to the draw tube, the method comprising:
pivoting the support member to a loading position disposed between an upright position and a lowered position;
locking the support member in the loading position;
securing the item to the support member;
unlocking the support member from the loading position;
pivoting the support member to an upright position; and
locking the support member in the upright position.

22. The method of claim 21, wherein unlocking the support member from the loading position comprises operating a lever to disengage a locking member from the support member.

23. The method of claim 21, wherein securing the item to the support member comprises attaching a retaining member to the support member and securing the item to the retaining member.

24. The method of claim 21, wherein securing the item to the support member comprises removing a first retaining member from the support member, attaching a second retaining member to the support member and loading the item in the second retaining member, wherein the first and second retaining members are configured to retain different types of items.

25. The method of claim 24, wherein one of the first and second retaining members comprises a bicycle rack and the other of the first and second retaining members comprises a cargo carrier.
